(19) United States
(12) Patent Application Publication
(10) Pub. No.: US 2010/0165245 A1
(43) Pub. Date: Jul. 1, 2010

(54) BACKLIGHT MODULE CAPABLE OF INCREASING LIGHT OUTPUT EFFICIENCY

(75) Inventor: CHAO-CHIANG CHANG, CHU-NAN (TW)

Correspondence Address: Flash Intellectual Property, Inc.;Attn. Cheng-Ju Chiang, P.O. Box 766, Chino, CA, 91708, US

(73) Assignee: TPO DISPLAYS CORP., CHU-NAN (TW)

(21) Appl. No.: 12/649,327

(22) Filed: Dec. 29, 2009

(30) Foreign Application Priority Data
Dec. 30, 2008 (TW) 097151502

(51) Int. Cl. G02F 1/1335; F21V 7/04

(52) U.S. Cl. 349/62; 362/611; 362/612

(57) ABSTRACT

A backlight module capable of increasing light output efficiency is disclosed. The backlight module includes a light emitting element, a light guide plate, a circuit board, and an intermediate layer. The light guide plate is disposed at a side of the light emitting element. The circuit board is disposed above the light emitting element and the light guide plate. The intermediate layer is disposed between the light emitting element and the light guide plate, and its light transmittance is greater than that of air. The intermediate layer decreases optical energy loss between the light emitting element and the light guide plate, and a goal to increase the light output efficiency of the backlight module is achieved. The present invention also improves an alignment between the light emitting element and the light guide plate when the light emitting element and the light guide plate are assembled together.

### BACKGROUND OF THE INVENTION

1. Field of the Invention

The present invention generally relates to a backlight module, and more particularly to a backlight module capable of increasing light output efficiency.

2. Description of Prior Art

Liquid crystal displays (LCDs) are being utilized in various products, for example, mobile phones, televisions, digital cameras, and computers. In the liquid crystal displays, liquid crystal alignment is controlled to change lights passing through the liquid crystal so as to display images. The liquid crystal cannot generate lights per se, and therefore a backlight module is utilized in the liquid crystal display as an external light source for providing lights that are required for displaying the images.

Please refer to FIG. 1A. FIG. 1A illustrates an exploded stereographic view of a conventional backlight module 10. The backlight module 10 mainly comprises prism sheets 104, 106, a diffusion sheet 108, a light guide plate (LGP) 110, a frame 112, a reflecting sheet 114, at least one light emitting element 116, and a flexible printed circuit board (FPCB) 120. The above elements are to fix the prism sheets 104, 106, and the diffusion sheet 108 on the light guide plate 110 by tapes (not shown) first. Then, the light guide plate 110 is assembled with the frame 112 and the reflecting sheet 114 to complete the assembly of the backlight module 10. A method of fixing the light emitting element 116 and the flexible printed circuit board 120 to the light guide plate 110 will be described later in detail.

When the light emitting element 116 such as a light emitting diode or a lamp generates lights, the light guide plate 110 guides the lights upwardly to the diffusion sheet 108. A function of the diffusion sheet 108 is to form uniform surface lights by refracting, reflecting, and scattering lights. A directionality of the lights passing through the diffusion sheet 108 is usually unsatisfactory, and therefore the prism sheets 104, 106 are utilized to modify light direction by refracting and reflecting the lights so as to increase light output efficiency after the lights pass through the diffusion sheet 108. In general, the prism sheets 104, 106 are also called brightness enhancement films (BEFs) and they are utilized for concentrating lights.

In addition, the reflecting sheet 114 is made of material of high reflectivity, and it is utilized for reflecting lights not received by the light guide plate 110 to the light guide plate 110 so as to increase the light output efficiency.

Please refer to FIG. 1B. FIG. 1B illustrates a cross-sectional view along a line 1B-1B′ in FIG. 1A. The flexible printed circuit board 120 is fixed on both the light emitting elements 116 and the light guide plate 110 by a tape 122. In the conventional fixing method, there exists a gap 118 between the light emitting element 116 and the light guide plate 110. As a result, some of the lights emitted by the light emitting element 116 are lost in air due to the gap 118.

When the light guide plate 110 and the light emitting element 116 are assembled together, a misalignment therebetween might occur and the gap 118 is generated in the assembling process accordingly. This makes the light output efficiency of the backlight module 10 worse.

In conventional techniques, liquid crystal display panel manufacturers seek for a way of increasing the light output efficiency of the backlight module 10. However, the objective is difficult to achieve. Therefore, there is a need to solve the above-mentioned problem of optical energy loss in the backlight module 10.

### SUMMARY OF THE INVENTION

A primary objective of the present invention is to provide a backlight module capable of increasing light output efficiency so as to decrease optical energy loss in the backlight module.

Another objective of the present invention is to provide a backlight module capable of increasing light output efficiency, and the backlight module improves an alignment when a light emitting element of the backlight module and a light guide plate of the backlight module are assembled together.

The backlight module capable of increasing the light output efficiency according to the present invention comprises a light emitting element, a light guide plate, a circuit board, and an intermediate layer. The light guide plate is disposed at a side of the light emitting element to receive lights emitted by the light emitting element. The circuit board is disposed above the light emitting element and the light guide plate to provide circuit arrangements of the backlight module. The intermediate layer is disposed between the light emitting element and the light guide plate. A light transmittance of the intermediate layer is greater than a light transmittance of air, and a refractive index of the intermediate layer is substantially equal to a refractive index of air.

The present invention is capable of decreasing the optical energy loss between the light emitting element and the light guide plate, and therefore the objective of increasing the light output efficiency of the backlight module is achieved. In addition, the alignment can be improved when the light emitting element and the light guide plate are assembled together.

### BRIEF DESCRIPTION OF THE DRAWINGS

FIG. 1A illustrates an exploded stereographic view of a conventional backlight module;

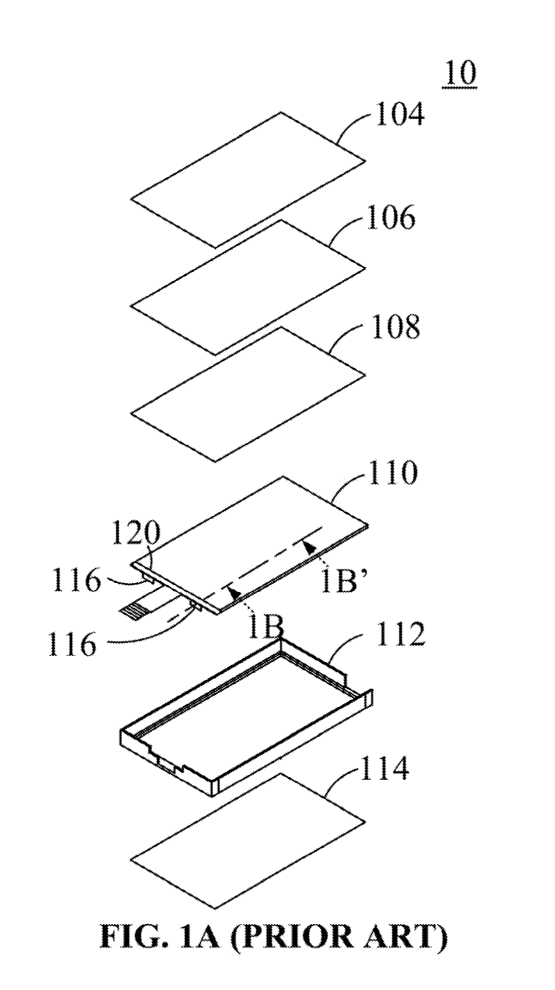

FIG. 1B illustrates a cross-sectional view along a line 1B-1B′ in FIG. 1A;

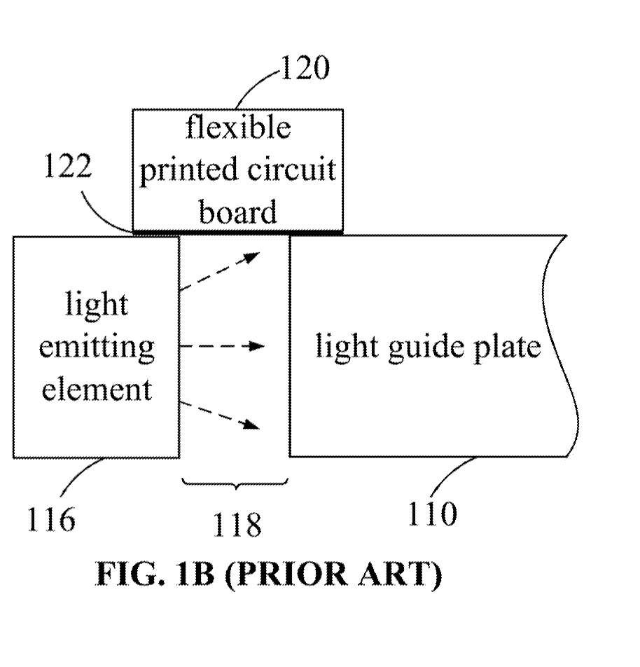

FIG. 2A illustrates a top view of a backlight module according to a preferred embodiment of the present invention;

FIG. 2B illustrates a cross-sectional view along a line 2B-2B′ in FIG. 2A; and

FIG. 3 illustrates a diagram of an electronic apparatus comprising a liquid crystal display.

### DETAILED DESCRIPTION OF THE INVENTION

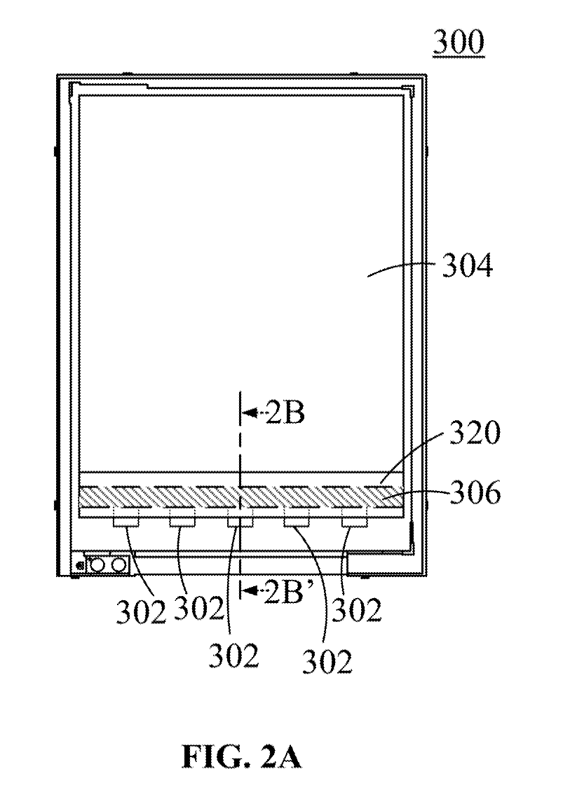

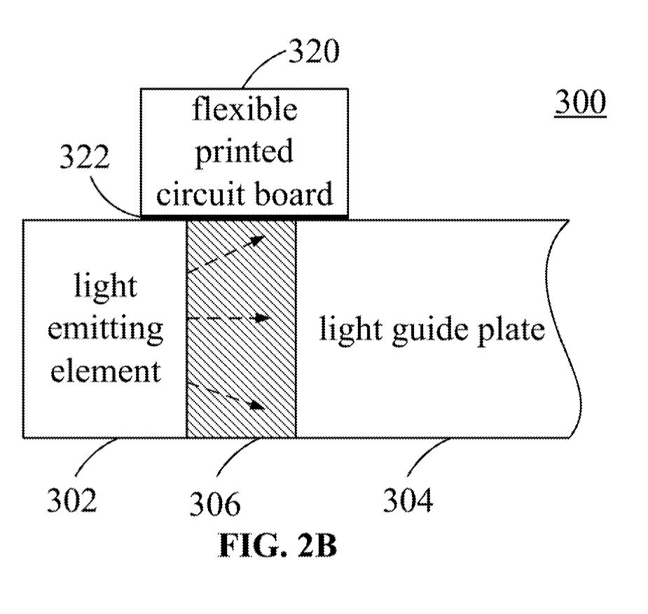

Please refer to FIG. 2A and FIG. 2B. FIG. 2A illustrates a top view of a backlight module 300 according to a preferred embodiment of the present invention. FIG. 2B illustrates a cross-sectional view along a line 2B-2B′ in FIG. 2A. The backlight module 300 mainly comprises light emitting elements 302, a light guide plate 304, an intermediate layer 306, and a flexible printed circuit board 320. The light emitting elements 302 can be light sources generally used in the backlight module 300, for example, light emitting diodes, lamps, or other usable light sources. The light guide plate 304 is disposed at a side of the light emitting elements 302 to receive lights emitted by the light emitting elements 302. The flexible printed circuit board 320 adheres to the tops of the both the light emitting elements 302 and the light guide plate 304 by using a tape 322. The flexible printed circuit board 320 provides circuit arrangements of the backlight module 300 for transmitting and controlling electrical signals.

As mentioned above, an air gap exists between the light emitting elements 302 and the light guide plate 304 in the backlight module 300 of prior arts. That is, the lights would be transmitted through air. Because the air is the medium through which the lights are scattered, this results in optical energy loss. According to the present invention, an intermediate layer 306 is disposed between the light emitting elements 302 and the light guide plate 304. The intermediate layer 306 is made of material having a light transmittance greater than a light transmittance of air, i.e. material of low haze, so as to achieve an object of increasing light output efficiency. Preferably, a refractive index of the intermediate layer 306 is substantially equal to a refractive index of the air, which is about 1.5 to 1.52.

Preferably, the intermediate layer 306 is made of soft and adhesive material. In an embodiment, the intermediate layer 306 is implemented by a film made of optical adhesive. The optical adhesive is filled between the light emitting elements 302 and the light guide plate 304 as the intermediate layer 306 to guide the lights of the light emitting elements 302 toward the light guide plate 304. As a result, the light output efficiency is increased. The optical adhesive can be a non-based adhesive material or a based adhesive material. One example of the based adhesive material is 3M™ Optically Clear Adhesives (OCAs), e.g. product numbers 8141, 8142, 8161, 8171, 8172, 9483. A light transmittance of the 3M™ OCAs is greater than 99% and a haze thereof is less than 1%. One example of the non-based adhesive material is CS3623 Transparent Double-coated adhesive tape manufactured by NITTO DENKO. A light transmittance of CS3623 is about 91.4%. In another embodiment, Super View Resin (SVR), which is a pasty resin, manufactured by Sony Chemical & Information Device Corporation is another choice for the intermediate layer 306. A light transmittance of SVR is greater than 95%. Furthermore, a tape having a light transmittance greater than air can also be a choice of the intermediate layer 306.

TABLE 1 shows specifications of elements of a conventional backlight module and the backlight module 300 of the present embodiment for testing the light output efficiency. The intermediate layer 306 is formed by 3M™ OCAs mentioned above.

TABLE 1

| element | prior art | | present embodiment | |
|---|---|---|---|---|
| upper prism sheet | 0.065 | millimeter (mm) | 0.065 | millimeter (mm) |
| lower prism sheet | 0.062 | millimeter (mm) | 0.062 | millimeter (mm) |
| diffusion sheet | 0.053 | millimeter (mm) | 0.053 | millimeter (mm) |
| light guide plate | 0.4 millimeter (mm)/ | | 0.4 millimeter (mm)/ | |
| | 0.5 millimeter (mm) | | 0.5 millimeter (mm) | |
| reflecting sheet | 0.065 | millimeter (mm) | 0.065 | millimeter (mm) |

| | | |
|---|---|---|
| light emitting | LT15056 5 sets | LT15056 5 sets |
| elements(light | | |
| emitting diodes) | | |
| intermediate layer | none | 3M ™ Optically |
| | | Clear Adhesives |

TABLE 2

| | | practical | theoretical | |
|---|---|---|---|---|
| | | output | output | light output |
| | | (milli candles | (milli candles | efficiency |
| | | (mcd)) | (mcd)) | (%) |
| prior art | backlight module | 3165 | 8450 | 37 |
| | backlight | 250 | 668 | 37 |
| | module + panel | | | |
| present | backlight module | 3399 | 8450 | 40 |
| embodiment | backlight | 264 | 668 | 40 |
| | module + panel | | | |

Each set of the light emitting elements outputs 1690 milli candles (mcd). Both the conventional backlight module and the backlight module 300 of the present embodiment utilize 5 sets of the light emitting elements. Therefore, a theoretical output is 1690*5=8450 mcd. A comparison of the conventional backlight module and the backlight module 300 of the present embodiment can be seen in TABLE 2 that the light output efficiency is increased from 37% to 40%. In addition, the conventional backlight module assembled with a panel is also compared with the backlight module 300 of the present embodiment assembled with a panel. A theoretical transmittance of a panel is 7.9%. Therefore, a theoretical output is 8450*7.9%=668 mcd. The comparison of the conventional backlight module assembled with the panel and the backlight module 300 of the present embodiment assembled with the panel can be seen in TABLE 2 that the light output efficiency is also increased from 37% to 40%. Since the light output efficiency of the backlight module is not easily increasable, an increase of 3% is a considerably great improvement.

In addition, brightness and color in the conventional backlight module and in the backlight module 300 of the present invention are measured based on the specifications listed in TABLE 1. TABLE 3 shows comparisons of the brightness and the color between the conventional backlight module and the backlight module 300 of the present invention. TABLE 4 shows comparisons of the brightness and the color between the conventional backlight module assembled with the panel and the backlight module 300 of the present invention assembled with the panel.

TABLE 3

| | backlight module | | | backlight module | | |
|---|---|---|---|---|---|---|
| | (conventional) | | | (present embodiment) | | |
| | brightness | color | | brightness | color | |
| | cd/m² | X | Y | cd/m² | X | Y |
| 1 | 2642 | 0.346 | 0.351 | 2833 | 0.349 | 0.354 |
| 2 | 2638 | 0.345 | 0.351 | 2842 | 0.348 | 0.354 |
| 3 | 2682 | 0.346 | 0.351 | 2894 | 0.348 | 0.355 |
| 4 | 3056 | 0.333 | 0.339 | 3222 | 0.336 | 0.342 |
| 5 | 3168 | 0.332 | 0.338 | 3399 | 0.334 | 0.342 |
| 6 | 2820 | 0.332 | 0.337 | 2993 | 0.335 | 0.341 |
| 7 | 3272 | 0.322 | 0.326 | 3537 | 0.324 | 0.329 |
| 8 | 3240 | 0.321 | 0.327 | 3350 | 0.325 | 0.333 |
| 9 | 3457 | 0.320 | 0.327 | 3600 | 0.323 | 0.332 |
| average | 2997 | | | 3186 | | |
| brightness | | | | | | |
| light | 76.3% | | | 78.7% | | |
| uniformity | | | | | | |

| | | | |
|---|---|---|---|
| compared with the center point of the | 107.3% | 0.0025 | 0.0037 |
| conventional backlight module | | | |

TABLE 4

| | backlight module + panel | | | backlight module + panel | | |
|---|---|---|---|---|---|---|
| | (conventional) | | | (present embodiment) | | |
| | brightness | color | | brightness | color | |
| | cd/m² | X | Y | cd/m² | X | Y |
| 1 | 209 | 0.344 | 0.370 | 218 | 0.349 | 0.354 |
| 2 | 207 | 0.344 | 0.371 | 218 | 0.348 | 0.354 |
| 3 | 210 | 0.344 | 0.370 | 221 | 0.348 | 0.355 |
| 4 | 239 | 0.331 | 0.357 | 248 | 0.336 | 0.342 |
| 5 | 250 | 0.330 | 0.356 | 264 | 0.334 | 0.342 |
| 6 | 223 | 0.330 | 0.356 | 234 | 0.335 | 0.341 |
| 7 | 256 | 0.319 | 0.343 | 272 | 0.324 | 0.329 |
| 8 | 256 | 0.318 | 0.344 | 262 | 0.325 | 0.333 |
| 9 | 277 | 0.319 | 0.345 | 283 | 0.323 | 0.332 |
| average | 236 | | | 247 | | |
| brightness | | | | | | |
| light | 74.8% | | | 76.9% | | |
| uniformity | | | | | | |

| | | | |
|---|---|---|---|
| compared with the center point of the | 105.4% | 0.0023 | 0.0028 |
| conventional backlight module assembled | | | |
| with the panel | | | |

It is noted that in a left column of TABLE 3, numbers 1-9 respectively represent nine points of different positions measured in the conventional backlight module and in the backlight module 300 of the present embodiment. In a left column of TABLE 4, numbers 1-9 respectively represent nine points of different positions measured in the conventional backlight module assembled with the panel and in the backlight module 300 of the present embodiment assembled with the panel. The number 5 in TABLEs 3, 4 represents the center point. In addition, X and Y in TABLEs 3, 4 respectively represent X-coordinate and Y-coordinate. The comparison of the conventional backlight module and the backlight module 300 of the present embodiment can be seen in TABLE 3 that an average brightness is increased from 2997 candles/meter² to 3186 candles/meter². Compared with the brightness of the center point (number 5) of the conventional backlight module, the brightness of the center point (number 5) of the backlight module 300 of the present embodiment is 107.3%. This means that the present embodiment promotes not only the light output efficiency, but also the brightness.

Furthermore, light uniformities in TABLEs 3, 4 are computed by the following equation: the minimum brightness/the maximum brightness. The comparison of the conventional backlight module and the backlight module 300 of the present embodiment can be seen in TABLE 3 that the light uniformity is increased from 76.3% to 78.7%, and this means that the light uniformity is increased about 2.4%. In addition, it can also be seen that color purity of the backlight module 300 of the present embodiment is not affected while the light output efficiency is increased.

Compared with the prior arts, the average brightness of the present embodiment shown in TABLE 4 is increased from 236 candles/meter² to 247 candles/meter² after the backlight module 300 is assembled with the panel. Compared with the brightness of the center point (number 5) of the conventional backlight module assembled with the panel, the brightness of the center point (number 5) of the backlight module 300 of the present embodiment assembled with the panel is 105.4%. In addition, the comparison of the conventional backlight module assembled with the panel and the backlight module 300 of the present embodiment assembled with the panel can be seen in TABLE 4 that the light uniformity is increased from 74.8% to 76.9%, and this means that the light uniformity is increased about 2.1%.

Please refer to FIG. 2B. Because the intermediate layer 306 is made of soft and adhesive material, the gap between the light emitting elements 302 and the light guide plate 304 can be effectively filled with the intermediate layer 306. Accordingly, the light emitting elements 302 and the light guide plate 304 can be assembled more firmly due to the adhesivity of the intermediate layer 306. As mentioned above, a misalignment often occurs when the light emitting elements 302 and the light guide plate 304 are assembled together. The gap between the light emitting elements 302 and the light guide plate 304 can be effectively filled with the intermediate layer 306, and therefore the problem of the misalignment of the light emitting elements 302 can be solved. As a result, the alignment is improved when the light emitting elements 302 and the light guide plate 304 are assembled together.

The backlight module capable of increasing the light output efficiency according to the present invention substitutes the intermediate layer having the light transmittance greater than the light transmittance of air for the air gap, so as to decrease the optical energy loss between the light emitting elements and the light guide plate. Therefore, the light output efficiency and the light uniformity can be increased. The present invention also can improve the alignment between the light emitting elements and the light guide plate when they are assembled together.

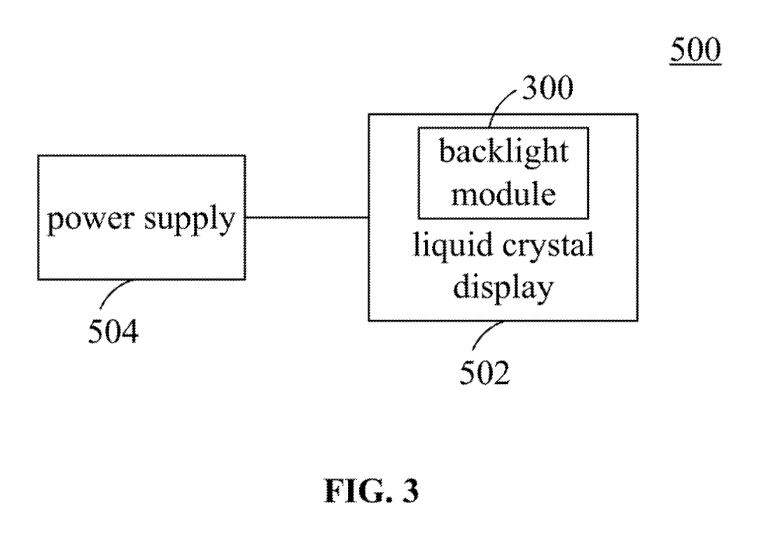

Please refer to FIG. 3. FIG. 3 illustrates a diagram of an electronic apparatus 500 comprising a liquid crystal display 502. The liquid crystal display 502 comprises the backlight module 300 capable of increasing the light output efficiency. The liquid crystal display 502 having the backlight module 300 shown in FIG. 3 can be a part of the electronic apparatus 500. The electronic apparatus 500 comprises the liquid crystal display 502 and a power supply 504. The power supply 504 is coupled to the liquid crystal display 502 for providing power for the liquid crystal display 502. The electronic apparatus 500 is a mobile phone, a digital camera, a Personal Digital Assistant, a notebook, a desktop computer, a television, a Global Positioning System, a vehicle display, an aeronautical display, or a portable digital video disc (DVD) player.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A backlight module capable of increasing light output efficiency, comprising:
a light emitting element;
a light guide plate disposed at a side of the light emitting element, for receiving lights emitted by the light emitting element;
a circuit board disposed above the light emitting element and the light guide plate, for providing circuit arrangements of the backlight module; and
an intermediate layer disposed between the light emitting element and the light guide plate, wherein a light transmittance of the intermediate layer is greater than a light transmittance of air.

2. The backlight module of claim 1, wherein the light emitting element is a light emitting diode or a lamp.

3. The backlight module of claim 1, wherein the circuit board is a flexible printed circuit board.

4. The backlight module of claim 1, wherein the intermediate layer has adhesiveness and adheres to the light emitting element and the light guide plate.

5. The backlight module of claim 1, wherein a refractive index of the intermediate layer is substantially equal to a refractive index of air.

6. The backlight module of claim 1, wherein the intermediate layer is made of soft material.

7. The backlight module of claim 1, wherein the intermediate layer is formed by a tape.

8. The backlight module of claim 1, wherein the intermediate layer is formed by optical adhesive.

9. The backlight module of claim 8, wherein the optical adhesive comprises a non-based adhesive material.

10. The backlight module of claim 8, wherein the optical adhesive comprises a based adhesive material.

11. The backlight module of claim 1, wherein the intermediate layer is formed by resin.

12. A liquid crystal display, comprising the backlight module of claim 1.

13. An electronic apparatus, comprising:
a liquid crystal display comprising the backlight module of claim 1; and
a power supply coupled to the liquid crystal display, for providing power to the liquid crystal display.

14. The electronic apparatus of claim 13, wherein the electronic apparatus is a mobile phone, a digital camera, a Personal Digital Assistant, a notebook, a desktop computer, a television, a television, a Global Positioning System, a vehicle display, an aeronautical display, or a portable DVD player.
